(19) United States
(12) Patent Application Publication
(10) Pub. No.: US 2018/0240176 A1
(43) Pub. Date: Aug. 23, 2018

(54) ELECTRONIC ROUTING AND MESSAGING IN A VENUE BASED ON ACTIVITY LEVEL

(71) Applicant: PANASONIC INTELLECTUAL PROPERTY MANAGEMENT CO., LTD., Osaka (JP)

(72) Inventors: John CRONIN, Bonita Springs, FL (US); Michael Glynn D'ANDREA, Burlington, VT (US); Kota MORISAKI, Arlington, VA (US)

(73) Assignee: PANASONIC INTELLECTUAL PROPERTY MANAGEMENT CO., LTD., Osaka (JP)

(21) Appl. No.: 15/438,017

(22) Filed: Feb. 21, 2017

(51) Int. Cl. G06Q 30/06; H04W 4/02; H04L 29/08; G01C 21/34; G01C 21/36

(52) U.S. Cl. CPC G06Q 30/0631; H04W 4/023; H04L 67/22; G01C 21/3691; G01C 21/3415; G01C 21/3484; G01C 21/343; G06Q 30/0639

(57) ABSTRACT

Routing a visitor through a venue includes acquiring desired attractions of a visitor and a desired activity level of the visitor. At least one of a route, venue activity, transportation mode, and food menu selection is recommended to the visitor based on the desired attractions of the visitor and the desired activity level of the visitor. A current location of the visitor is tracked via a wearable device of the visitor. A current activity level of the visitor is acquired via the wearable device. A comparison is performed of the current activity level of the visitor and the desired activity level of the visitor. At least one of the recommended route, venue activity, transportation mode, and food menu selection may be updated based on the current location of the visitor and a comparison of the current activity level of the visitor with the desired activity level of the visitor.

### BACKGROUND

### 1. Field of the Disclosure

The present disclosure relates to the field of resorts, theme parks, amusement attractions, and other venues having attractions. More particularly, the present disclosure relates to electronically routing and messaging in a venue based on activity level.

### 2. Background Information

Resorts, theme parks, and amusement attractions provide a visitor with enjoyment as the visitor navigates about the venue, attends attractions in the venue, interacts with various games and contests, attends live entertainment, and enjoys food and drink. Individuals have different desires, expectations, and tolerances with respect to an amount of physical activity and environmental conditions associated with the experience.

### BRIEF DESCRIPTION OF THE DRAWINGS

FIG. 1 shows an exemplary general computer system that includes a set of instructions for electronic routing and messaging in a venue based on activity level, according to an aspect of the present disclosure;

FIG. 2 shows an exemplary venue associated with electronic routing and messaging in a venue based on activity level, according to an aspect of the present disclosure;

FIG. 3 shows an exemplary architecture schematic for electronic routing and messaging in a venue based on activity level, according to an aspect of the present disclosure;

FIG. 4A shows an exemplary flow diagram for electronic routing and messaging in a venue based on activity level, according to an aspect of the present disclosure;

FIG. 4B shows an exemplary flow diagram for electronic routing and messaging in a venue based on activity level, according to an aspect of the present disclosure;

FIG. 4C shows an exemplary flow diagram for electronic routing and messaging in a venue based on activity level, according to an aspect of the present disclosure;

FIG. 4D shows an exemplary flow diagram for electronic routing and messaging in a venue based on activity level, according to an aspect of the present disclosure

FIG. 5 shows an exemplary flow diagram, according to an aspect of the present disclosure;

FIG. 6 shows an exemplary flow diagram of visitor wait time calculation for electronic routing and messaging in a venue based on activity level, according to an aspect of the present disclosure;

FIG. 7 shows an exemplary diagram of visitors waiting in line for an attraction, electronic routing and messaging in a venue based on activity level, according to an aspect of the present disclosure;

FIG. 8A shows exemplary circuit components of a wearable monitor, electronic routing and messaging in a venue based on activity level, according to an embodiment of the present disclosure;

FIG. 8B is an exemplary flow diagram illustrating logic for receiving a biological parameter from the wearable band of the visitor

FIG. 9 shows an exemplary diagram of visitors interacting with visitors in the venue, electronic routing and messaging in a venue based on activity level, according to an aspect of the present disclosure;

FIG. 10 shows an exemplary visitor record with visitor preferences, electronic routing and messaging in a venue based on activity level, according to an aspect of the present disclosure; and

FIG. 11 shows an exemplary visitor record with desired activity levels, electronic routing and messaging in a venue based on activity level, according to an aspect of the present disclosure.

### DETAILED DESCRIPTION

In view of the foregoing, the present disclosure, through one or more of its various aspects, embodiments and/or specific features or sub-components, is thus intended to bring out one or more of the advantages as specifically noted below.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods. Further, any reference to claim elements in the singular, for example, using the articles “a,” “an” or “the”, is not to be construed as limiting the element to the singular.

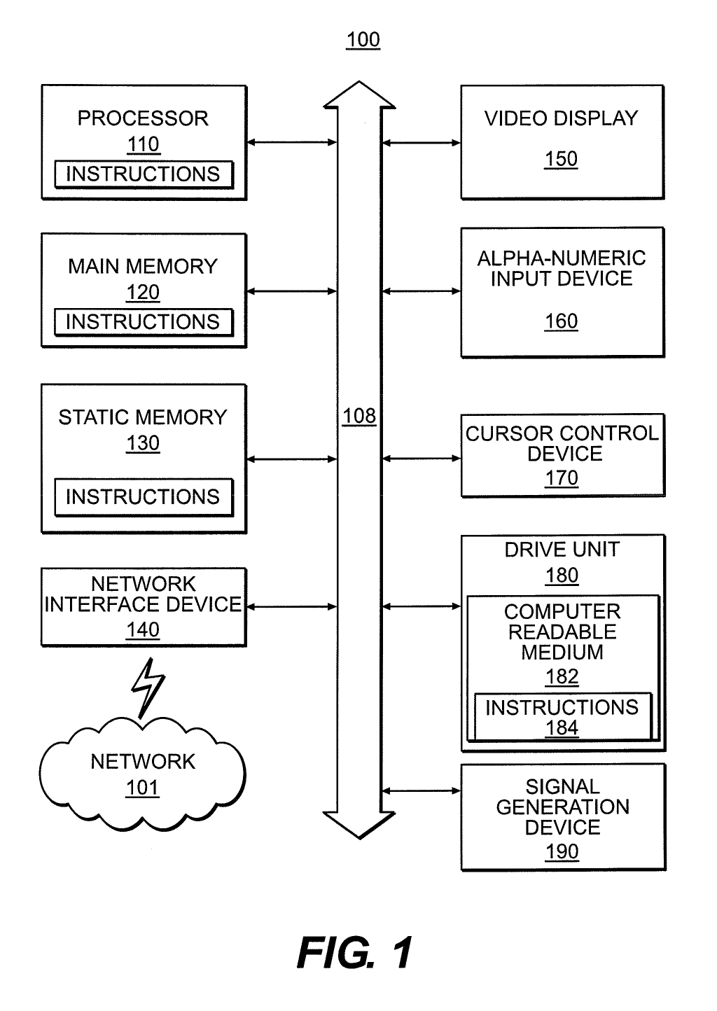

FIG. 1 is an illustrative embodiment of a general computer system, on which a method of electronic routing and messaging in a venue based on activity level can be implemented, and which is shown and is designated 100. The computer system 100 can include a set of instructions that can be executed to cause the computer system 100 to perform any one or more of the methods or computer based functions disclosed herein. The computer system 100 may operate as a standalone device or may be connected, for example, using a network 101, to other computer systems or peripheral devices.

In a networked deployment, the computer system 100 may operate in the capacity of a server or as a client user computer in a server-client user network environment, or as a peer computer system in a peer-to-peer (or distributed) network environment. The computer system 100 can also be implemented as or incorporated into various devices, such as a stationary computer, a mobile computer, a personal computer (PC), a laptop computer, a tablet computer, a wireless smart phone, a set-top box (STB), a personal digital assistant (PDA), a global positioning satellite (GPS) device, a communications device, a control system, a camera, a web appliance, a network router, switch or bridge, virtual reality system, augmented reality system, a sensor, and monitor, or any other machine capable of executing a set of instructions (sequential or otherwise) that specify actions to be taken by that machine. The computer system 100 can be incorporated as or in a particular device that in turn is in an integrated system that includes additional devices. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 includes a processor 110. A processor for a computer system 100 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. A processor is an article of manufacture and/or a machine component. A processor for a computer system 100 is configured to execute software instructions in order to perform functions as described in the various embodiments herein. A processor for a computer system 100 may be a general purpose processor or may be part of an application specific integrated circuit (ASIC). A processor for a computer system 100 may also be a microprocessor, a microcomputer, a processor chip, a controller, a microcontroller, a digital signal processor (DSP), a state machine, or a programmable logic device. A processor for a computer system 100 may also be a logical circuit, including a programmable gate array (PGA) such as a field programmable gate array (FPGA), or another type of circuit that includes discrete gate and/or transistor logic. A processor for a computer system 100 may be a central processing unit (CPU), a graphics processing unit (GPU), or both. Additionally, any processor described herein may include multiple processors, parallel processors, or both. Multiple processors may be included in, or coupled to, a single device or multiple devices.

Moreover, the computer system 100 includes a main memory 120 and a static memory 130 that can communicate with each other via a bus 108. Memories described herein are tangible storage mediums that can store data and executable instructions, and are non-transitory during the time instructions are stored therein. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. A memory described herein is an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted.

As shown, the computer system 100 may further include a video display unit 150, such as a liquid crystal display (LCD), an organic light emitting diode (OLED), a flat panel display, a solid state display, or a cathode ray tube (CRT). Additionally, the computer system 100 may include an input device 160, such as a keyboard/virtual keyboard or touch-sensitive input screen or speech input with speech recognition, and a cursor control device 170, such as a mouse or touch-sensitive input screen, pad, augmented reality input device, visual input device, video input device, 3D input device, human eye position input device, haptic input device, body tracking device, acoustic tracking device, or a data glove. The computer system 100 can also include a disk drive unit 180, a signal generation device 190, such as a speaker or remote control, and a network interface device 140.

In a particular embodiment, as depicted in FIG. 1, the disk drive unit 180 may include a computer-readable medium 182 in which one or more sets of instructions 184, e.g. software, can be embedded. Sets of instructions 184 can be read from the computer-readable medium 182. Further, the instructions 184, when executed by a processor, can be used to perform one or more of the methods and processes as described herein. In a particular embodiment, the instructions 184 may reside completely, or at least partially, within the main memory 120, the static memory 130, and/or within the processor 110 during execution by the computer system 100.

In an alternative embodiment, dedicated hardware implementations, such as application-specific integrated circuits (ASICs), programmable logic arrays and other hardware components, can be constructed to implement one or more of the methods described herein. One or more embodiments described herein may implement functions using two or more specific interconnected hardware modules or devices with related control and data signals that can be communicated between and through the modules. Accordingly, the present disclosure encompasses software, firmware, and hardware implementations. Nothing in the present application should be interpreted as being implemented or implementable solely with software and not hardware such as a tangible non-transitory processor and/or memory.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionality as described herein, and a processor described herein may be used to support a virtual processing environment.

The present disclosure contemplates a computer-readable medium 182 that includes instructions 184 or receives and executes instructions 184 responsive to a propagated signal; so that a device connected to a network 101 can communicate voice, video or data over the network 101. Further, the instructions 184 may be transmitted or received over the network 101 via the network interface device 140.

The present disclosure employs a distributed architecture to continuously monitor wait times at attractions as well as a visitor's current location. When a wait time at a visitor's intended attraction exceed a pre-determined threshold, the combination of hardware and software components interact to calculate an attraction closest to the present location of the visitor's location and/or route that most closely matches the interests of the visitor. Furthermore, the combination of hardware components may identify an incentive, based upon a stored profile of the visitor, that would be most likely to succeed in motivating the visitor to alter their intended route. In doing so, ride condition, wait times, and visitor location are constantly monitored to determine accurate wait times. Thus, an on the fly minimization of visitor wait times may be achieved. As used herein, attractions may be rides, restaurants, booths, exhibits, games, bars, activities, events, presentations, etc.

Furthermore, the distributed architecture enables load distribution, reducing congestion and bottlenecks, while still allowing the data to be accessible from a central location.

As a result, venue operators and managers can route visitors away from attractions that the visitors have expressed an interest in visiting when the current estimated wait time is too great, and route the visitors to alternate attractions that match the interests of the visitors but have shorter wait times. Therefore, the overall satisfaction with the experience is increased.

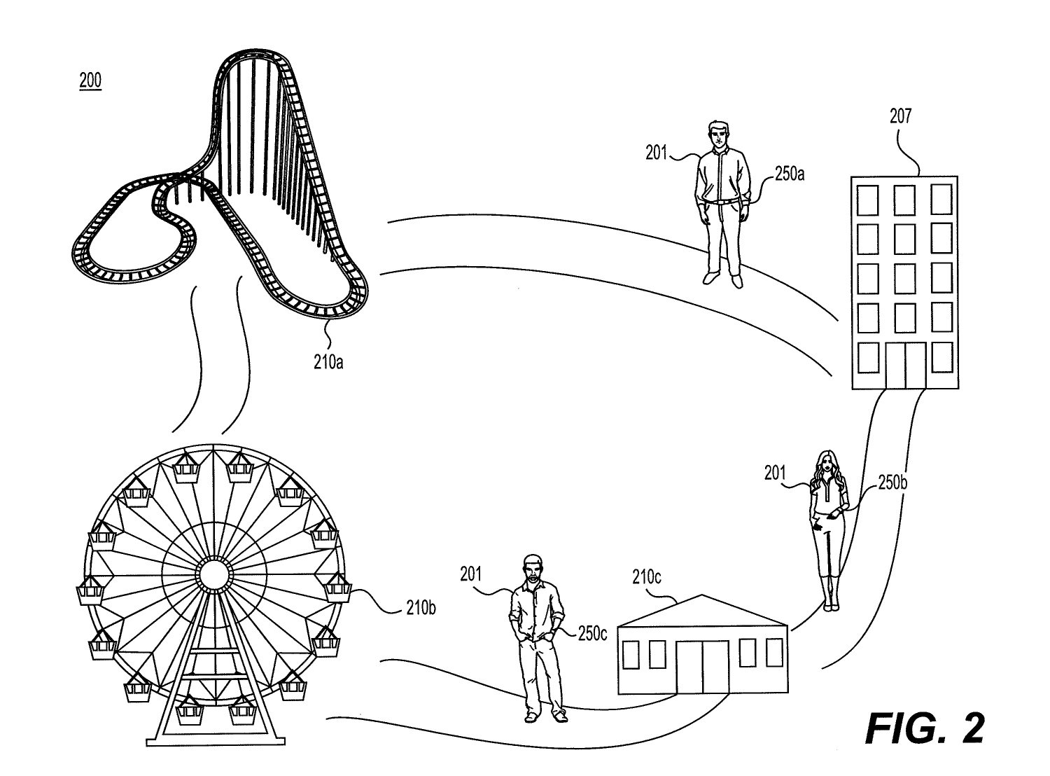

FIG. 2 is an illustrative embodiment of a venue 200, in which a method of electronic routing and messaging in a venue based on activity level may be implemented. The method, and various embodiments thereof, may be implemented locally within a predetermined device. On the other hand, some or all of the steps of the method may be implemented on an external network. Exemplary venue 200 includes one or more attractions 210a-c which may be attended by one or more visitors 201. Furthermore, the one or more visitors 202 may wait in lines in order to gain entry to the attractions 210a-c.

Also shown in FIG. 2 is a hotel 207 that includes one or more rooms of various dimensions and shapes to satisfy the preferences of the visitors 201. The hotel 207 may be located inside the venue 200 or outside of the venue 200. The venue 200 may refer to any one or more of a resort, hotel, travel destination, theme park, amusement park, hiking park, casino, golf course, museum, campus, or travel destination, for example. In a non-limiting example, the venue 200 may refer to a resort. In an alternative non-limiting example, the venue 200 may refer to a hotel and an amusement park. Specifically, the venue 200 encompasses any facility, location, or place, providing physical boundaries to fulfill one or more objectives of the present disclosure.

The visitors 201 may physically occupy a premise on venue 200 for a duration of time. In addition, the visitors 201 may directly compensate the operator, or an entity related to the operator, for its services provided to visitors 201. Alternatively, the visitors 201 may not be expected to compensate for services provided them, such as where another entity pays on behalf of the visitor 201 or the visitor 201 does not incur expenses by visiting the venue 200.

The term operator, as used herein, may refer to any entity acting on behalf of the venue 200 who may affect the satisfaction of its visitors 201. For example, an operator may be a travel management company, or alternatively, an operator may be a government entity. A non-exhaustive and exemplary list of operators may include both nonprofit and for-profit entities. In addition to travel management companies, for-profit operators may include entities engaged in earning profits at amusement parks, casinos, museums, resorts, hotels, or other venues. Also, in addition to government entities, nonprofit operators may include educational universities or arts organizations, for example.

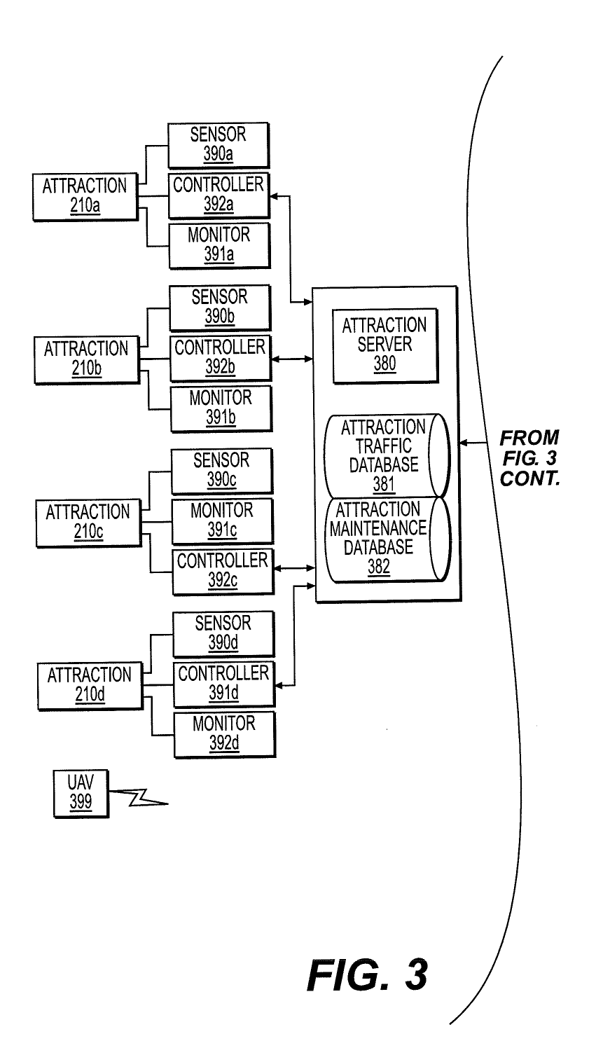

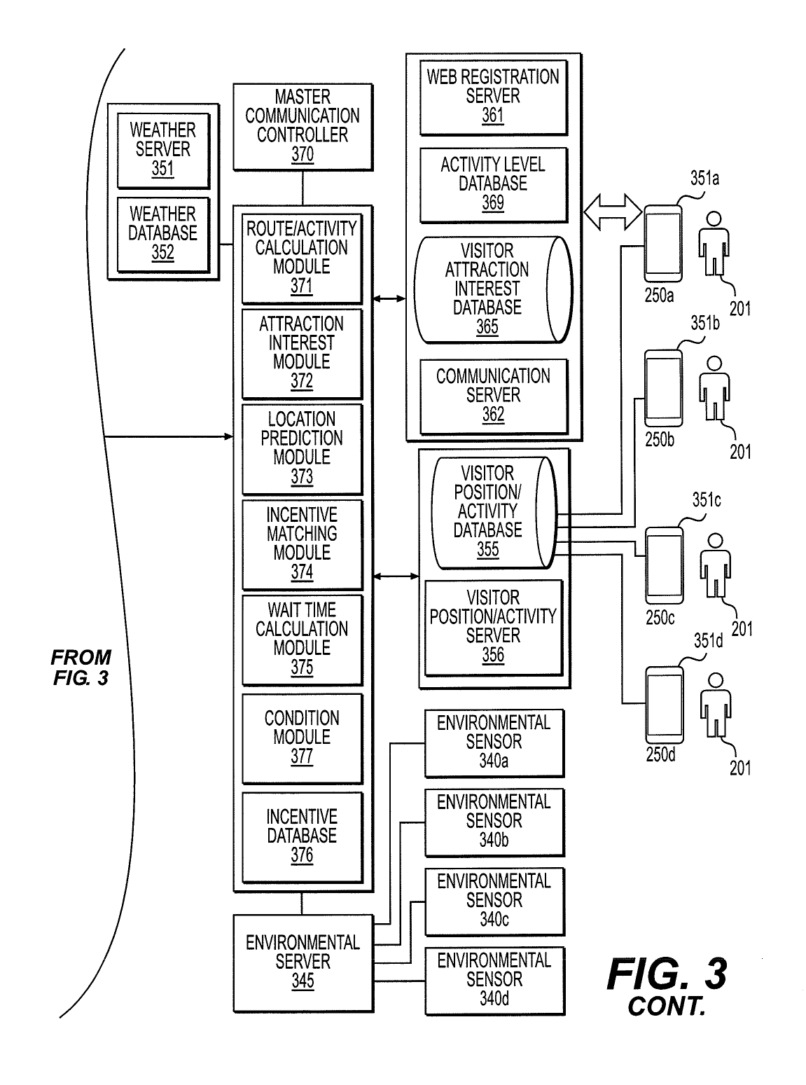

As noted, the venue 200 includes one or more attractions 210a-c. At times, each attraction may include at least one visitor 201 waiting in line to experience one or more of the attractions 210a-c. Each of the visitors 201 has a ticket such as an electronic ticket, which allows the visitor 201 to access the attractions 210a-c in the venue 200. In one embodiment, the electronic ticket is displayable on a mobile device 250a-c of the visitors (as shown in FIG. 3). For example, the electronic ticket may be displayable on a graphical user interface (GUI) of a smartphone or on a GUI of a wearable band such as a wrist band. The GUI of the mobile device 250a-c also permits the visitor to receive incentives, coupons, messages, and offers from the venue operators or other entities within the venue such as vendors. It is clear that while a number of visitors 201 and attractions 210a-c are shown, the actual number of each is virtually limitless.

FIG. 3 shows an exemplary architecture schematic of the system for electronic routing and messaging in a venue based on activity level, according to an aspect of the present disclosure. It is clear that any type of wireless mobile devices are contemplated for mobile devices 250a-c, including wearable wireless devices, computers, tablets, fitness bands, bracelets, necklaces, caps, anklets, trackers, cameras, smart glasses, and Bluetooth™ devices, smartphones, and the like.

A mobile application 351a-d is accessible with or installed upon each of the mobile devices 250a-d. The mobile devices 250a-d of the visitors 201 are used to track the respective visitor 201 as the visitor 201 traverses the venue 200 and attends in attractions 210a-d. In addition to tracking the location of the visitor 201, the mobile devices 250a-d are configured to monitor an activity level of the visitor 201, as well as certain biological parameters of the visitor 201, as will be discussed below.

For example, global positioning satellite (GPS) coordinates associated with the location of the mobile devices 250a-d are obtained. That is, the geographic coordinates of the mobile devices 250a-d are determined by communications between the mobile devices 250a-d and one or more satellites (not shown). The determined geographic coordinates are then transmitted from the mobile devices 250a-d, or from sensors around the venue 201 that receive GPS signals from the mobile devices 250a-d, to a visitor position database 355. This process is performed continuously so the location of each visitor 201 wearing a mobile device 250 is always known.

The applications 351a-d may be downloaded to the mobile devices 250a-d or accessed via the mobile devices 250a-d at the time the visitors 201 enter the venue 200, while the visitors are already in the venue 200, or prior to the visitors' arrival at the venue 200. In an embodiment, information on the applications 351a-d on the mobile devices 250a-d of the visitors serves as the electronic ticket for the venue 200, providing access to the venue 200 and the attractions 210a-d.

In one embodiment, when the visitors 201 download or access the mobile applications 351a-d, the mobile applications 351a-d present the visitor 201 with a survey page via the GUI on the mobile devices 250a-d. The survey solicits demographic, attraction interest, fitness information, food preferences, weather preferences, and hobby interests of the visitors 201 that will be used to calculate one or more routes for the visitor 201 through the venue 200, including making recommendations to the visitor 201 as to certain routes to take to visit attractions of interest to the visitor 201, various activities within the venue that would likely be of interest to the visitor 201 based on the hobby interests of the visitor 201, transportation options for the visitor 201, and food menu selections for the visitor 201 based on the food preferences of the visitor and caloric expenditure of the visitor 201.

For example, the survey solicits from the visitor 201 what attractions that the visitor 201 would like to visit. In one embodiment, the survey permits the visitor 201 to rank the attractions according to an order of preference. The survey may allow the visitor 201 to input a list of attractions or present a list of attractions from which the visitor may select, for example, by checking a box or clicking indicia on the display. Based upon the visitor 201 input, an itinerary may be automatically generated for the visitor 201, including a map displaying a route to all of the attractions 210a-c identified by the visitor 201 to be of interest, which is displayed on the mobile device 250 of the visitor 201. In one embodiment, multiple routes will be sent to the mobile device 250 of the visitor 201 for selection by the visitor 201. Alternatively, the itinerary may be manually generated by the visitor by using the mobile applications 351a-d. For example, the visitor 201 may reserve or get a priority pass for some of the attractions 210 at a respective designated time, in advance. In this regard, the mobile application 351a-d may display each name of each of the reserved attractions and the respective reserved times corresponding to the reserved attraction, such that the visitor 201 could ride on the reserved attraction at the designated time without waiting for a long time (e.g., without any wait—even moving ahead of others who do not have a reservation of a priority pass.

Additionally, the survey solicits information from the visitor 201 as to their desired level of activity while at the venue 200. For example, the survey may pose questions to the visitor 201 as to whether the visitor is interested in walking long distances to attractions 210a-d, whether the visitor 201 likes indoor versus outdoor attractions, whether the visitor 201 likes shaded outdoor environments or sunny environments. The survey may be based on weather conditions forecast for the day the visitor 201 is at the venue 200 or for the day that that the visitor 201 is expected to be at the venue 200, for example, if a ticket is purchased in advance. Additional survey input options will be discussed below.

As another example, the visitor 201 may be asked if they prefer water rides or scary roller coasters. In a casino, the visitor 201 may be asked if they prefer blackjack, craps, or roulette. With regard to food and drink, the visitors 201 may be asked what type of food they prefer. The survey questions may be opened ended, allowing the visitor 201 the freedom to enter words of their choice. Alternatively, survey questions may be close ended in which choices may be provided from which the visitor may make one or more selections. A combination of open ended and close ended survey questions may also be provided. By soliciting such interests of the visitors 201 via the mobile application 351a-d of the mobile device 250a-c in advance, the claimed features are able to provide a fast and tailored system, leading to enhanced visitor enjoyment.

A web registration server 361 provides a web and Internet interface and presents the visitors 201 with the survey and subsequently receives the survey responses from the visitor 201. The survey responses are then transmitted from the registration server 361 to a visitor attraction interest database 365 for storage. The survey responses pertaining to a desired activity level, fitness level, or medical conditions by the visitor 201 are transmitted to an activity level database 369.

A communication server 362 handles communications with other elements in the system, including those depicted in FIG. 3. Such communications may be wired, wireless, or any combination thereof. For example, once the survey is completed, the communication server 362 may set up a record for the visitor 201 in the visitor attraction interest database 365 and/or the activity level database 369.

The visitors are registered, for example, in the web registration server 361, so that the venue 200 may present to the visitor a route or recommended route through the venue 200 that will include the preferred attractions indicated by the visitor 201 in the survey in conjunction with a desired activity level indicated by the visitor 201 in the survey. The calculated route or routes are transmitted to the mobile device 250a-d. Additionally, survey answers provided by the visitor 201 allow the venue 200 to offer incentives to the visitor 201 that are determined to be appealing to the visitor 201. For example, if the visitor 201 indicated in the survey that they like pizza, an incentive offered to the visitor 201 may be associated with a pizzeria in the venue 201.

A weather server 351 is configured to receive current and future weather reports as to conditions around the venue 200. The current and future weather reports are stored in a weather database 352. The weather reports are used to help during the routing of visitors 201 through the venue. That is, for visitors who have indicated in the aforementioned survey that they prefer or do not prefer certain weather conditions (e.g., hot/cold, dry/wet, humid, sunny/shady), routes are recommended to the visitor 201 in accordance with the visitor preferences 201. Since weather conditions are constantly changing, the present system advantageously provides a system that dynamically and rapidly adapts to such changes on the fly.

As part of the registration process, the visitor 201 may be assigned an identification number which is stored in the registration server 361. In lieu of an arbitrary identification number, a smartphone telephone number or communications address may be used. By virtue of the registration process, the venue 200 is able to distinguish between visitors 201, given that each visitor has either a smartphone or wearable band with such an identifying number.

With regard to the identification of the position of the visitors 201, several techniques may be used, including GPS, RFID, Wi-Fi, NFC, Bluetooth, cellular, etc. For example, the mobile devices 250a-d of the visitor 201 are configured to interact with various sensors in the venue 200, and with satellites in the case of GPS. The various sensors then transmit location information including the identifying numbers of the visitor 201 or device 250, to the visitor position/activity server 356 for storage in the visitor position/activity database 355. As will be discussed, various fitness, health, and/or biological information obtained via the mobile devices 250a-d are similarly obtained and transmitted to the visitor position/activity server 356 for storage in the visitor position/activity database 355.

Additional or other techniques for determining the position of the visitors 201 may be employed. For example, the mobile devices 250a-c may have imaging devices such as a camera and/or a scanner. In this regard, the visitor 201 may be prompted by the communication server 362 or visitor position/activity server 356, or requested at various locations in the venue 200 to scan or photograph indicia located at various points in the venue 200, which are used to determine the position of the visitors 201. For example, the visitors 201 may be prompted to scan or photograph QR codes, bar codes, or other indicia adjacent to attractions in the venue 200. In one aspect, the communication server 362 or the visitor position/activity server 356 sends a request to the mobile devices 250a-d of the visitors 201 to scan or photograph indicia located along a route of the venue 201. In another aspect, static or electronic signs near certain attractions 210a-d may request that the user scan or photograph nearby indicia. In another aspect, rather than static or electronic signs near certain attractions 210a-d, the visitors 201 may be transmit or receive signals or a message via the mobile devices 250a-d from an unmanned aerial vehicle (UAV) 398 such as a drone. Such signals between the visitors 201 and the UAV 398 may be via Bluetooth™, Wi-Fi, cellular, or the like. The signals exchanged between the visitors 201 and the UAV 398 may be used to identify the particular visitor, for example, a MAC address of the mobile devices 250a-d, with the UAV transmitting the identifying information back to the visitor position/activity sever 356 for storage in the visitor position/activity database 355.

Using the mobile application 351a-d, the visitors 201 may upload any scanned image or photograph to a visitor position/activity server 356, which stores the visitor position in the visitor position/activity database 255.

In an embodiment, the visitors 201 may earn bonus points for photographing or scanning the aforementioned indicia within the venue 200. The bonus points may then be applied toward purchases of food, drink, or souvenirs in the venue 200. Such bonus points would encourage compliance with any photographing or scanning.

A master communication controller 370 controls communications between modules, databases, and other servers in the venue 200. For example, the master communication controller 370 may monitor the visitor position/activity database 355 and route/activity calculation module 371, attraction interest module 372, location prediction module 373, incentive matching module 374, wait time calculation module 375, condition module 377, and incentive database 376. The master communication controller 370 may also monitor an attraction traffic database 381 and an attraction information database 382, the weather server 351, the weather database 352, and communicate with an attraction server 380, the visitor position server 356, and the communication server 362. The master communication controller 370 may be a centralized processor or server.

The route/activity calculation module 371 stores an updatable map of the venue 200 and calculates one or more routes or paths through the venue 200 for each visitor 201. For example, the route/activity calculation module 371 calculates a first visitor route based on the visitor attraction information stored in the visitor attraction interest database 365 and the visitor activity level information stored in the activity level database 369. The visitor attraction information stored in the visitor attraction interest database 365 and the visitor activity level information stored in the activity level database 369 may be pushed or pulled from the visitor attraction interest database 365, between the master communication controller 370 and the communication server 362. The route/activity calculation module 371 calculates all routes for the visitor 201 that incorporate all of the attractions 210a-c indicated to be of interest to the visitor 201.

The attraction interest module 372 receives the visitor attraction interest information stored in the visitor attraction interest database 365 and visitor activity level information stored in the activity level database 369 and ranks for each visitor the visitor attraction information according to survey information provided by each of the visitors 201.

The visitor location prediction module 373 predicts the movement and behavior of visitors 201 as they traverse the venue 200. The visitor location prediction module 373 may include a database used to predict in real time the future behavior of a guest for which a partial trajectory is available. Such a partial trajectory might be computed from various location-sensing technologies, such as GPS on a smartphone, worn RFID tags read by fixed sensors, facial recognition via cameras, or even point-of-sale payment records. Typically, such a trajectory might be incomplete, since all known location-sensing technologies produce incomplete data due to missed or erroneous readings. To address this issue, embodiments may find the closest match in the set of exemplar trajectories for the partial trajectory. The closest match can then be used as the basis for predicting the locations that the guest will soon visit. This approach uses approximate or fuzzy string matching, in which a query string, in this case the partial trajectory, is matched against substrings in a dictionary of strings, in this case the exemplar trajectories in the database. The subject matter in U.S. Patent Application Publication No. 2014/0278688 is incorporated by reference in its entirety.

The incentive matching module 374 determines an incentive to offer the visitors 201, which is used to motivate the visitors 201 to visit an identified attraction. The incentive matching module 374 receives information that was obtained and stored in the visitor attraction interest database 365 and the visitor activity level information stored in the activity level database 369 to identify potential incentives that may be of interest to the visitor. For example, if the visitor 201 had indicated in the aforementioned survey that the visitor likes t-shirts, the incentive matching module 374 may determine to offer an e-coupon to the visitor 201 for a t-shirt. The e-coupon incentive may be for a vendor or establishment within the venue 200, or for a merchant not affiliated with the venue 200.

The wait time calculation module 375 determines wait times for attractions of interest to the visitor 201. In this regard, attraction traffic information stored in attraction traffic database 381 is used by the wait time calculation module 375, as well as the information from the visitor attraction interest database 365 and the visitor activity level information stored in the activity level database 369. The attraction traffic information stored in the attraction traffic database 381 may be pushed or pulled from the attraction traffic database 381, between the master communication server 370 and attraction sever 380.

The incentive database 376 stores incentives for identified interest attractions of a visitor 201. For example, the match between identified interest attractions of a visitor may be represented as a key-value pair in the incentive database 376, as will be discussed below. Alternately, the incentive database 376 may be a relational database.

The condition module 377 receives weather forecast data from the weather database 352 and environmental sensor data from the environmental servers 340a-d via the environmental server 345. The condition module uses the visitor activity level information stored in the activity level database 369 to assist the route/activity calculation module 371 in identifying and recommending attractions and routes to the visitor 201.

Environmental sensors 340a-d are positioned at various locations throughout the venue 200. The environmental sensors 340a-d are configured to measure, for example, temperature, humidity, wind speed, precipitation, barometric pressure, etc. Weather information obtained by the environmental sensors 340a-d is transmitted by environmental server 345 to the master communication controller 370. For example, temperature may be measured by thermometer, humidity by hygrometer, etc. As another example, shade versus sunlight may be measured by a light level sensor.

The attraction server 380 controls the distribution of information from the attraction traffic database 381 and attraction maintenance database 382 to the master communication controller 370. Traffic sensors 390a-d are configured to determine wait lines at the attractions 210a-c.

The traffic sensors 390a-d may be configured to detect anonymous device IDs from the mobile devices 250a-d of the visitors. In this regard, the number of anonymous device IDs received from a particular coverage area corresponds to a number of persons in line. In another embodiment, the traffic sensor 390a-d utilizes an infrared sensor using break-beam technology. For example, the traffic sensor 390a-d may be an infrared beam counter in which a horizontal infrared beam is projected across an attraction entrance, and that records a count each time the beam is broken. Another similar sensor may also be positioned at or near the exit of the attraction, in which cases visitors 201 leaving the attraction may be subtracted from visitors 201 entering the attraction.

In this regard, a transmitter and a receiver may be mounted on either side of an attraction 210a-d entrance. In another embodiment, the traffic sensors 390a-d are video-based sensors to detect persons walking or occupying a viewing area. The video-based sensors are configured to determine a direction of travel, entry, exit, and retains objects in its zone of detection in order to avoid counting the same person multiple times. The video-based sensors may be mounted adjacent the attraction entrances and/or exits.

A video counter that counts persons using camera imaging by the number of persons recorded may alternately be employed. In this regard, adaptive algorithms may be used to provide video counting. In another aspect, the use of artificial intelligence or pattern recognition may be used to enhance the accuracy of video counting.

In yet another embodiment, a 3D sensor may be used that creates a 3D view of the direction area, enabling depth perception and the ability to calculate persons walking in any direction. In this regard, the 3D sensor is able to monitor multiple persons entering and exiting at the same time and distinguish between persons and objects. The 3D sensor may be mounted adjacent the attraction entrance and/or attraction exit.

In another embodiment, the traffic sensors 390a-d are thermal imaging counter using one or more array sensors that detect heat sources. In this regard, the thermal imaging counter is a directional sensor, which can provide entrance and exit count data using a lens with thermal imaging technology, detecting human infrared radiation.

In another embodiment, the traffic sensors 390a-d are a Wi-Fi receivers that may pick up unique Wi-Fi management frames emitted from mobile devices 250a-d within range, for example, from the MAC address or other broadcast identifiers used with the mobile devices 250a-d.

It is noted that any combination of the types of traffic sensors 390a-d may be used in the various attractions 210a-c, and that certain attractions 210a-c may be better suited for certain types of the aforementioned traffic sensors 390a-d. It is further noted that the traffic sensors 390a-d may be positioned at entrances, exits, along waiting line areas of the attractions 210-d. Any of the aforementioned sensors may be located overhead in order to avoid any undesirable tampering.

In an embodiment, the traffic sensors 390a-d determine the number of persons in line by observing the length of the line. For example, indicia may be placed at pre-determined locations along the waiting line area, and if the line of persons extends as far as the indicia, the traffic sensors 390a-d determine that the indicia corresponds with a pre-determined number of persons (e.g., twelve linear feet corresponds to eight persons). For example, a beam based traffic sensor 390 can detect the presence or lack of objects (i.e., persons) extending upon a linear waiting line path, adjacent linear distance indicia. In an embodiment, the traffic sensors 390a-d may send data each time a length of the line changes. The wait time calculation module 375 calculates an approximate waiting time for a person who lines up at the end of the current line. The approximate waiting time calculated by the wait time calculation module may take into account the number of persons in line, plus the actual ride times. For example, if the number of persons currently waiting in line is 51 and the ride seats 25 at one time, then at least two rides will be completed before visitor number 51 is seated.

The traffic sensors 390a-d transmit the number of visitors waiting in line for an attraction to the attraction traffic database 381 where the data is stored. The attraction traffic database 381 receives from each traffic sensor 390a-d the number of visitors waiting in line for an attraction and stores the data. The attraction traffic database 381 makes this information available to the master communication controller 370 at predetermined intervals. However, continuous or periodic polling of the traffic sensors 390a-d and/or the monitors 391a-d by the master communication controller 380 or the attraction server 370 may also be performed to calculate wait times or visitor routes, as needed. In an embodiment, the attraction sensors 390a-d and/or the condition monitors 391a-d may transmit data to the attraction server 380 continuously or periodically without polling.

In addition to polling, a heartbeat signal may be sent from the attraction server 380 at predetermined intervals to ensure that the sensors 390a-d and/or the monitors 391a-d are operating properly. For example, a heartbeat signal may be sent from the attraction server 380 to the sensors 390a-d and/or the condition monitors 391a-d if data from the attraction sensors 390a-d and/or the monitors 391a-d has not been received in a predetermined period of time. As another example, a continuous heartbeat signal may be sent from the attraction server 380 to the sensors 390a-d and/or the monitors 391a-d such that any interruption in proper functioning of the sensors 390a-d and/or the monitors 391a-d is detected immediately.

In an embodiment, a polling protocol may utilize a MAC protocol in which the sensors 390a-d and/or the monitors 391a-d send data to the attraction server 380 all the time. The attraction sever 380 may periodically transmit polling packets that contain IDs for the sensors 390a-d and/or the monitors 391a-d, by which the sensors 390a-d and/or the monitors 391a-d take turns transmitting data to the attraction server 380. The turns may be determined according to location of the sensors 390a-d and/or the monitors 391a-d, load of the sensors 390a-d and/or the monitors 391a-d in which the sensors 390a-d and/or the monitors 391a-d at busier attractions 210a-d may be able to transmit prior to the sensors 390a-d and/or the monitors 391a-d at slower attractions 210a-d, etc. In this embodiment, the sensors 390a-d and/or the monitors 391a-d may reside in a sleep mode when there is no data to transmit and wake up when there is data to transmit. In this regard, the sensors 390a-d and/or the monitors 391a-d may wait by monitoring the polling packet for its ID. Advantageously, this solution avoids collisions as only one of the sensors 390a-d and/or the monitors 391a-d can transmit to the attraction server 380 at one time.

The attraction condition monitors 391a-d detect conditions of the attractions. For example, if an attraction 210a-c is closed or out of service, the attraction condition monitors 290a-d detect such a condition and send such condition to the attraction maintenance database 382. The attraction monitors 391a-d may also include run times of the attractions 210a-d, number of visitors 201 that may participate in the attraction 210a-d at one time, and the like. For example, the attraction monitors 391a-d may track the length of a particular ride and the number of persons a ride can accommodate at one time. That is, the number of persons that can be accommodated in a ride at one time may vary, for example, based upon the number of cars being used on a roller coaster at a given time, which may vary due to maintenance schedules, peak hours, and the like. The attraction monitors 391a-d may accept input by attraction operators and may include video cameras. A maintenance history and/or schedule of the attractions 210a-c may also be stored in the attraction maintenance database 382.

The attraction condition information is obtained through attraction monitors 391a-d. For example, if a particular attraction is undergoing maintenance, if the attraction operator is on break, then the attraction monitor 390a-d will send a message to the attraction maintenance database 382. The attraction information database 382 will subsequently send a message to the master controller 370 indicating with the information from the attraction monitors 391a-d. The attraction information in the attraction information database 382 may also include information about each attraction, such as height of a roller coaster, number of visitors the roller coaster can carry at one time, the minimum height required to ride the roller coaster, etc.

The attraction traffic information is obtained through attraction sensors 390a-d that are adjacent to or in the vicinity of each attraction. For example, the attraction sensors 390a-d detect the number of persons at an attraction (e.g., waiting in line for an attraction, viewing an attraction, interacting with an attraction). The attraction sensors 390a-d send a message to the attraction traffic database 381 for storage, thus additionally providing a historical indication of days and times of busy/idle times of each attraction 210a-d. The attraction traffic database 381 will subsequently send a message with information in the attraction traffic database 381 to the master controller 370.

In one embodiment, the attraction monitors 391a-d are infrared photoelectric sensors that are used to identify a position of a care on a roller coaster ride for example. In this regard, a transmitter on the attraction monitors 391a-d projects an infrared beam of light toward a possible location of a roller coaster. A receiver reports when it sees the beam of light, and if it does not seem the beam of light, it will transmit a signal indicating that a roller coaster is not present.

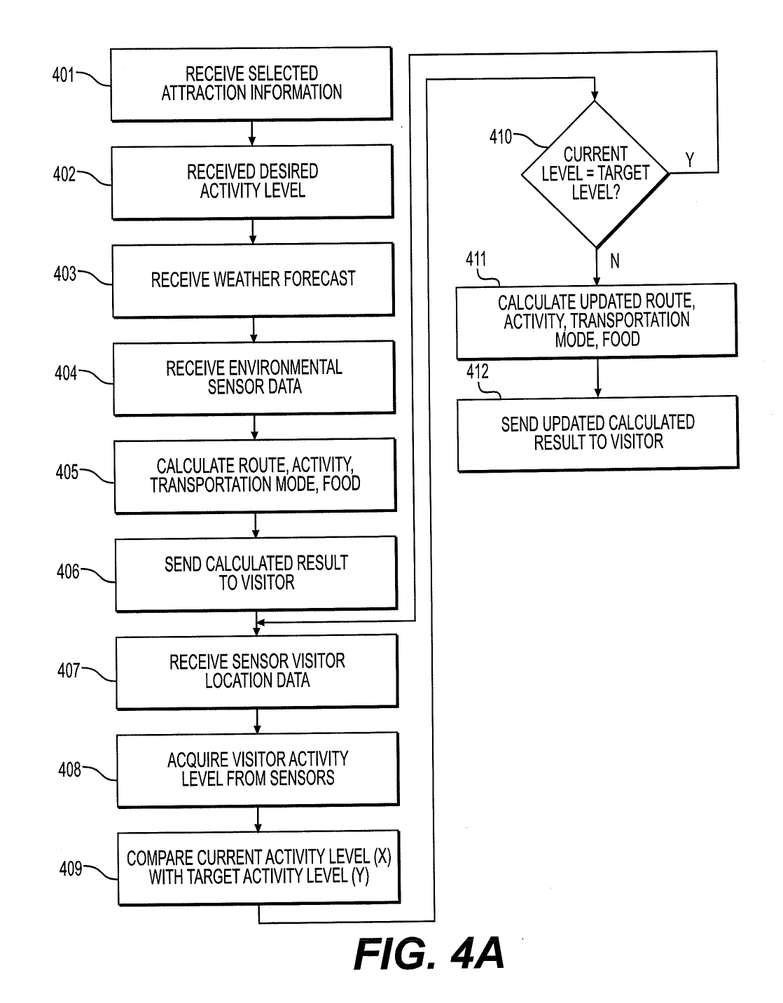

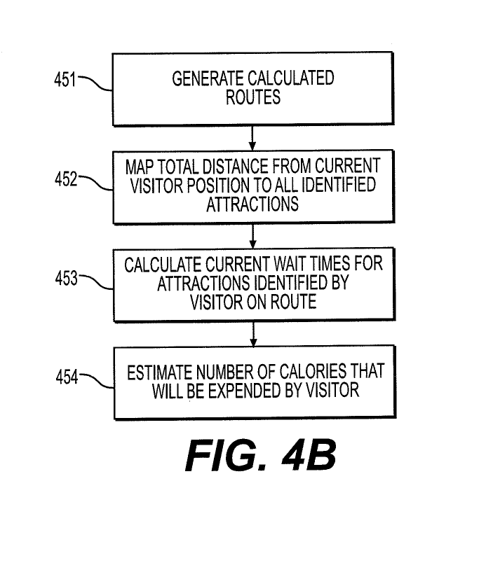

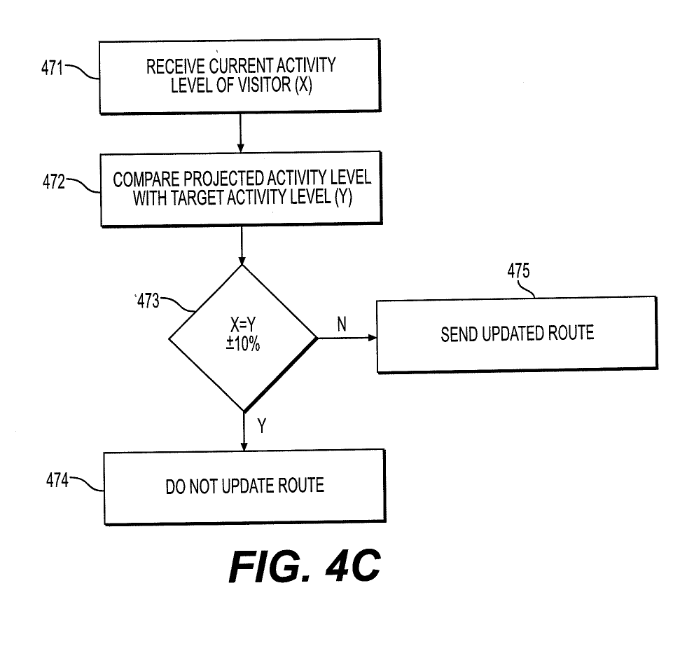

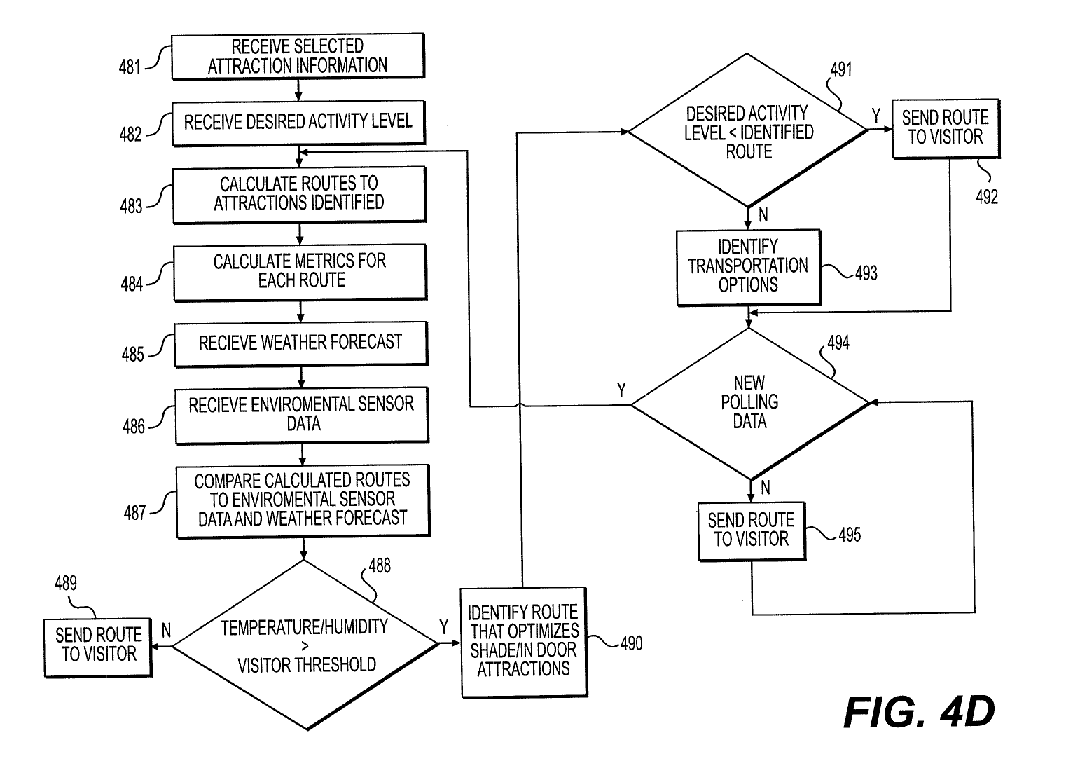

FIG. 4A exemplary flow diagram of electronic routing and messaging in a venue based on activity level, according to an aspect of the present disclosure.

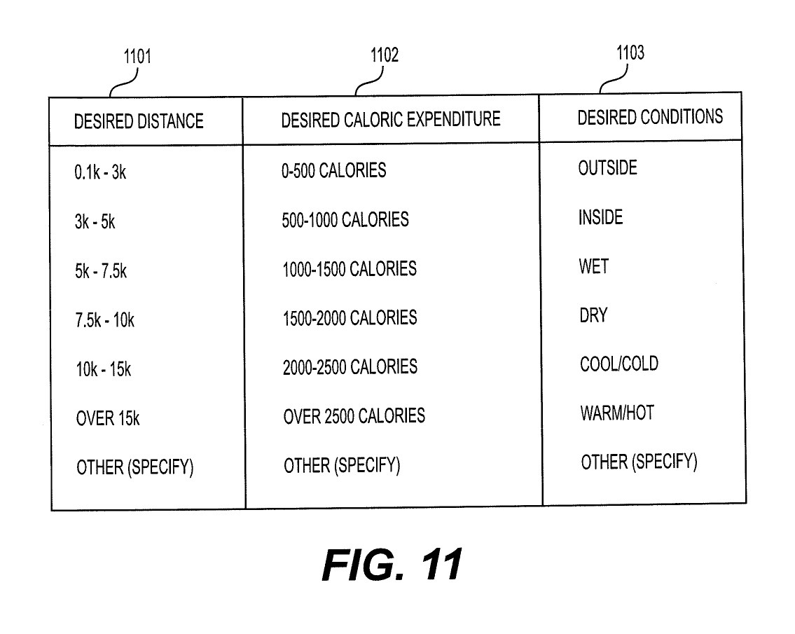

At step 401, visitor attraction interest information from the visitor attraction information database 365 is received. At step 402, desired activity level information from the activity level database 369 is received. The desired activity level information may include distance, caloric, and environmental conditions, as will be discussed with respect to FIG. 11, but also may include medical conditions of the visitor 201. The information in steps 481 and 482 are initially derived from the aforementioned survey. If the visitor attraction interest information and the desired activity level information are received, a list of suggested itineraries corresponding to the desired activity level may be displayed on the mobile application 351a-d. Each of suggested itineraries may define a route including at least one of the attractions of interest of the visitor 201 included in the visitor attraction interest information. That is, if the visitor 201 desires a high activity level, each of routes, defined by the suggested itineraries, corresponding to the high activity level is longer than another route corresponding to low activity level. In another example, each of the suggested itineraries may correspond to different activity levels. For example, if the visitor 201 desires activity level “2”, the suggested itineraries may include a first route which corresponds to activity level “1” lower than the desired activity “2” level and is shorter than a second route corresponding to the desired activity level “2”, the second route, and a third route which corresponds to activity level “3” higher than the desired activity level “2” and is longer than the second route (i.e., the application 351a-d will automatically display at least one route lower than a desired activity level of the visitor 201 and at least one route higher than a desired activity level of the visitor, affording the visitor 201 an opportunity to move down or up with respect to a desired activity level, but still be close to the desired activity level). When one of the suggested itineraries is selected by the visitor 201 with the application 351a-d, the selected itinerary is set on the application 351a-d and the application 351a-d may display a route to a next attraction and time schedule.

At step 403, the condition module 377 receives weather forecast data from the weather database 352. At step 404, the condition module 377 receives environmental sensor data from the environmental sensors 340a-d via the environmental server 345.

At step 405, the route/activity calculation module 371 calculates at least one of a recommended route, venue activity, transportation mode, and food menu selection, based on the visitor's selected attraction information, the environmental data, and the weather forecast date that were received in steps 401-404. The recommended route, venue activity, transportation mode, and food menu selection is/are sent to the mobile device 250 of the visitor 201 at step 406.

At step 407, visitor location data is received by the location prediction module 373 or the route/activity calculation module 371. As discussed herein, the visitor location data is obtained through interaction between the mobile device 250 of the visitor 201 and that various beacons (sensors) or GPS satellites around the venue 200.

At step 408, an activity level of the visitor 201 is obtained by the visitor position/activity server 356. As discussed herein, the visitor activity level data is obtained through the mobile device 250 of the visitor 201, the readings of which are read by the various beacons (sensors) around the venue 200.

At step 409 a comparison of the current activity level (X) with the target activity level (Y) is performed to ascertain whether the visitor 201 is on track with the target activity level. That is, at some point, planned or unplanned departures from previously planned, routes, activities, transportation modes, and/or food selections can affect the target activity level.

At step 410, the current level is on par with the target level at a given point in time (e.g., within 10%), (step 410=YES), then no change is made; however, control proceeds to step 407 so as to continuously monitor the activity level of the visitor 201. If step 410=NO, then the route/activity calculation module 371 calculates an updated route, activity, transportation mode, food selection at step 411. Then, at step 412, the updated calculated result from step 411 is sent to the mobile device 250 of the visitor 201. Thus the set itinerary may be updated accordingly.

FIG. 4B shows an exemplary flow diagram for a subroutine of calculating metrics for each calculated route in the step 403, according to an aspect of the present disclosure.

At step 451 calculated routes are generated by the route/activity calculation module 371. At step 452, the route/activity calculation module 371 maps a total distance from a current position of the visitor 201, obtained from the visitor position database 355, to all of the attractions identified by the visitor 201 as stored in the visitor attraction interest database 365. For example, the route/activity calculation module 371 uses the GPS coordinates of the present position of the visitor and known GPS coordinates of all of the attractions in the venue 200, to create a sum of the distances of the various segments of the route, i.e., from point A to B, point B to C, point C to D, etc. Thus, the route/activity calculation module 371 calculates the distance of each segment of the route and the total distance of the entire route.

At step 453, the wait time calculation module 375 calculates the current wait times (i.e., rest/queue time) for all of the attractions on the route as identified by the visitor 201. The wait time calculation module 375 derives the current wait times from the sensors 390a-d. In this regard, the total amount of wait time or rest time is identified, which may be a factor in visitors not wishing to walk long distances without having an opportunity to rest.

At step 454, the condition module estimates the number of calories that the visitor will burn by traversing the entire route. In order to derive an estimate of the calories that the visitor will burn by traversing the entire route, the condition module 377 uses information stored in the visitor attraction interest database 365. For example, information provided by the visitor 201 during registration may include the age of the visitor 201, the sex of the visitor 201, the height of the visitor 201, the weight of the visitor, and general fitness level of the visitor 201.

For example, for men, an exemplary caloric expenditure algorithm is calories burned=[(age×0.2017)−(weight×0.09036)+(heart rate×0.6309)−55.0969]× time/4.184. Similar, for women, an exemplary caloric expenditure algorithm is calories burned=[(age×0.074)−(weight×0.05741)+(heart rate×0.4472)−20.4022]×time/4.184.

In an embodiment, the estimated number of calories that the visitor will burn may be updated in real time based upon a detected heart rate, steps taken, and/or sweat factors. For example, with a wearable band, a heart rate monitor, sweat sensor, and step sensor may be included.

FIG. 4c is a flow diagram of a subroutine for determining whether a modified route is required, according to an aspect of the present disclosure.

At step 471, the route/activity calculation module 371 receives a current projected activity level (X) of the visitor 201. At step 472, the route/activity calculation module 371 compares the received current projected activity level of the visitor 201 with the target activity level (Y) indicated by the visitor 201. The current projected activity level of the visitor 201 and the target activity level of the visitor 201 may be measured in calories expended.

At step 473, if the current projected activity level of the visitor 201 is more or less than the target activity level, then the route/activity calculation module 373 modifies the route of the visitor so that the current or forecast activity level of the visitor 201 will match the target activity level of the visitor 201. That is, if X is not within plus/minus 10% of Y, the modified route will be sent to the mobile device 250a-d of the visitor 201, at step 475 and the set itinerary may be updated accordingly. Otherwise, the route is not updated at step 474. While 10% is used herein, any predetermined percentage may be used.

For example, if the visitor 201 had indicated a desire to walk 10 k-15 k during the present visit to the venue 200, and the visitor is currently at 3 k and is projected by the route/activity calculation module 373 to walk only another 4 k after visiting all of the attractions identified to be of interest to the visitor 201, then the route/activity calculation module 371 may modify the remainder of the route of the visitor 201 so that 3 k-8 k will be traversed by the visitor 201, thus meeting the target activity level of the visitor 201. In this regard, the modified route will be sent to the mobile device 250 of the visitor 201. That is, route deviations on the part of the visitor 201 may cause an actual activity level of the visitor 201 to be higher or lower than a target activity level, even if the initial route was planned according to the target activity level of the visitor 201. Thus, the specific problem of a visitor 201 having an undesirable activity level is reduced or eliminated, based on the dynamically optimized features of the present disclosure. Furthermore, by virtue of the dynamically optimized features of the present disclosure, the performance of the system as a whole is enhanced.

FIG. 4d shows another exemplary flow diagram of electronic routing and messaging in a venue based on activity level, according to an aspect of the present disclosure.

At step 481, visitor attraction interest information from the visitor attraction information database 365 is received. At step 482, desired activity level information from the activity level database 369 is received. The desired activity level information may include distance, caloric, and environmental conditions, as will be discussed with respect to FIG. 11, but also may include medical conditions of the visitor 201. The information in steps 481 and 482 are initially derived from the aforementioned survey.

At step 483, the route/activity calculation module 371 calculates all routes that will include all of the attractions 210a-n that the visitor 201 indicated during registration to be attractions of interest to the visitor 201.

At step 484, for each route calculated, the route/activity calculation module 371 calculates a total distance of each of the calculated routes, the distance of each segment (i.e., distance between each of the attractions 210a-n that the visitor identified to be of interest), the current wait and/or rest times associated with each of the attractions 210a-n that the visitor identified to be of interest, and the estimated number of calories burned for each of the calculated routes if traversed by the visitor 201.

At step 485, the condition module 377 receives weather forecast data from the weather database 352. At step 486, the condition module 377 receives environmental sensor data from the environmental sensors 340a-d via the environmental server 345. At step 487, the condition module 377 compares each of the calculated routes to the environmental sensor data and the weather forecast data.

At step 488, it is determined whether at least one weather condition (e.g., temperature, humidity, wind speed, etc.) exceeds a visitor defined threshold (from the survey), as stored in activity level database 369. If the weather condition does not exceed the visitor defined threshold (step 488=NO), then the recommended calculated routes are sent to the mobile device 250 of the visitor 201 at step 489. If the weather condition exceeds the visitor defined threshold (step 488=YES), the route/activity calculation module 371 identifies a route that optimizes a condition desired by the visitor 201 at step 490. For example, if the visitor 201 had indicated that they prefer less humid or indoor conditions, then the route/activity calculation module 371 identifies a route that optimizes or maximizes the visitor's time indoors or in shaded areas of the venue 201 at step 490.

If the desired activity level of the visitor is less than that required for the identified route (step 491=YES), then the route is sent to the mobile device 250 of the visitor 201 at step 492. If, however, the desired activity level of the visitor is more than that required for the identified route (step 491=NO), then the route/activity calculation module 371 identifies transportation options for the visitor at step 413. For example, the identified transportation options (e.g., shuttle, cable car, golf cart, tram, bus, etc.) are sent to the visitor 201 with the optimized or maximized route determined at step 490. The optimized route may also include one or more activities, one or more modes of transportation, and one or more menu selections.

After the route is sent to the visitor at step 492, new polling data is obtained to determine and updating a recommendation of at least one of the route, activity, transportation mode, and food menu selection. Thus, the system is advantageously continuously updating its recommendations in accordance with preference of the visitor 201, weather conditions, activity level of the visitor 201, etc.

At step 494, one or more of the environmental sensors 340a-d, sensors 390a-d, monitors 392a-d, the visitor position/activity database 355, and the weather database 352 are polled for any new data. If no new data is obtained from the polling (step 494=NO), the maximized route is sent to the visitor 201 at step 495. If new data is obtained from the polling (step 494=YES), then control returns to step 403.

While the visitor attraction interest information may be obtained, for example, when the visitor initially downloads the mobile application 351a-d in an alternative embodiment, another survey, which may be updated based on a variety of factors including venue conditions, may be presented to the visitor 201 as the visitor 201 traverses the venue.

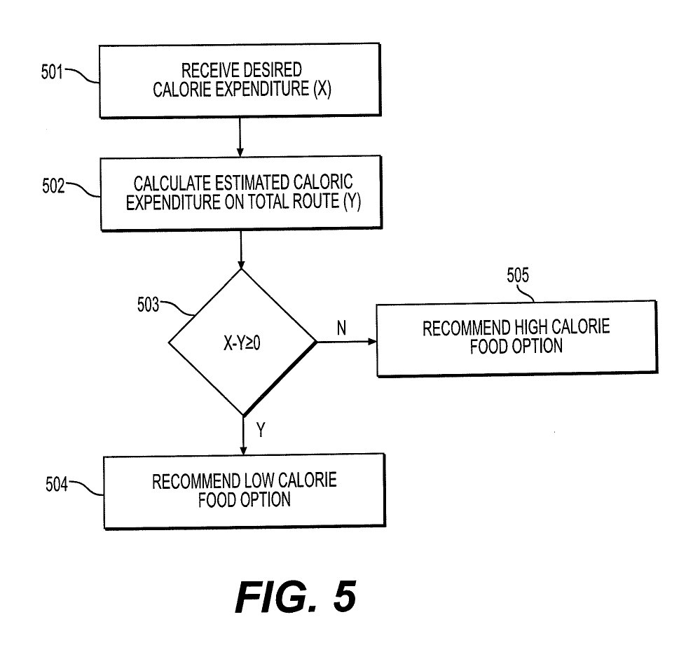

FIG. 5 is a flow diagram for determining a menu selection for the visitor, according to an aspect of the present disclosure.

At step 501 the desired caloric expenditure (X) for the visitor 201 is received by the route/activity calculation module 371. At step 502, an estimation of the caloric expenditure for the total route (Y) calculated for the visitor is made. At step 503, a determination of whether the visitor 201 is projected to have a caloric surplus or caloric deficit is made. If the visitor 201 is determined to have a caloric surplus, then low caloric menu items are recommended to the visitor 201 at step 504, by transmitting a message to the mobile device of the visitor 201. On the other hand, if the visitor 201 is determined to have a caloric deficit, then low caloric menu items are recommended to the visitor 201 at step 505, by transmitting a message to the mobile device of the visitor 201. The menu items are sent to the mobile device 250 of the visitor 201 along with a route to food establishments within the venue 201 having such menu selections. While high caloric and low caloric menu items are used herein, specific food recommendations may transmitted to the visitor 201.

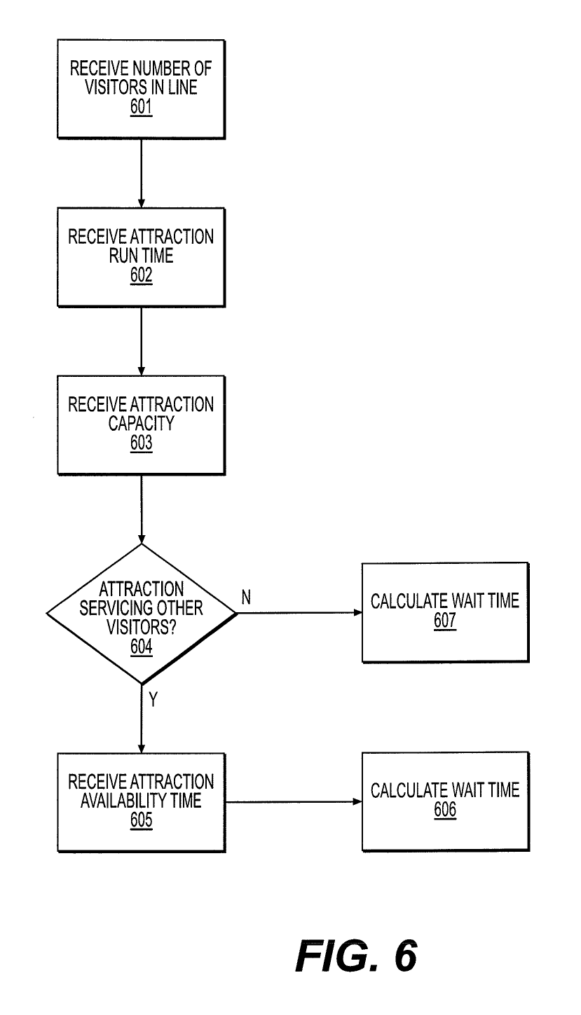

FIG. 6 shows an exemplary flow diagram for estimating wait time at an attraction at the venue, according to an aspect of the present disclosure.

At step 601, the wait time calculation module 375 receives the number of visitors at an attraction 210 from the attraction server 380, which is stored in the attraction information maintenance database 382. At step 602, the wait time calculation module 375 also receives the attraction run time of the attraction, which is stored in the attraction information database 382. At step 603, the wait time calculation module 375 receives the attraction run time number of visitors that can partake in the attraction at one time (i.e., the attraction capacity), which is stored in the attraction information database 382. At step 604, the wait time calculation module 375 receives an indication as to whether the attraction 210a-d is currently servicing other visitors from the attraction server 380, which is stored in the attraction information database 382. If the attraction is currently servicing other visitors (step 604=YES), the wait time calculation module 375 receives at step 605 an estimated time of when the attraction 210 will be available from the attraction information database 382. The wait time calculation module 375 then determines the estimated wait time at step 606. For example, if the attraction is a roller coaster, and if the attraction 210 run time is 5 minutes and attraction is currently one-half of the way through the ride, according to the monitor 391, then the wait time calculation module 375 determines that the attraction is available in approximately 2 minutes 30 seconds.

Then, if the attraction 210 can seat 100 visitors and there are 75 visitors in line, the wait time calculation module determines that the wait time is approximately 2 minutes 30 seconds. However, if there are more than 100 visitors in line, then the wait time calculation module 375 will determine that the wait time for the first 100 visitors in line is approximately 2 minutes 30 seconds. If there are more than 100 visitors in line, the wait time determines that the wait time is approximately 7 minutes 30 seconds for visitors 101-200 in line; approximately 12 minutes 30 seconds for visitors 201-300 in line, etc.

If step 604=NO, then the wait time calculation module 375 then determines the estimated wait time at step 607. For example, if the attraction is not serving other visitors 201, then the wait time may be less than one minute.

Since visitors may be joining or departing the line continuously, the master communication controller 370 or the attraction server 380 may poll the sensors 390a-d, 391a-d, and/or controllers 390a-d for information regarding the number of visitors in line and condition of the attraction 210a-d.

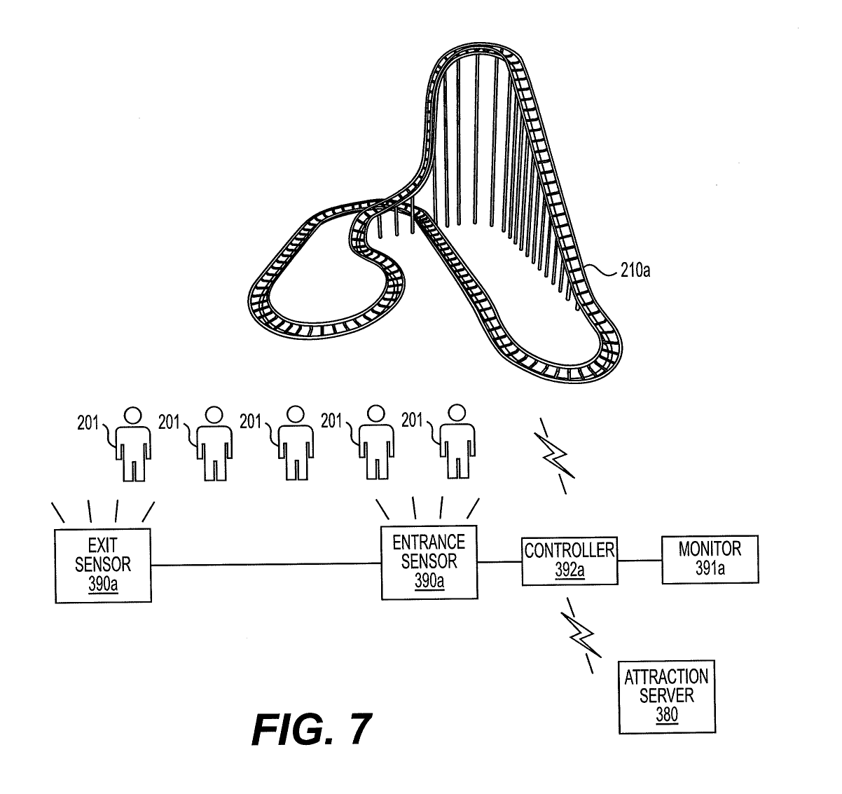

FIG. 7 shows an exemplary diagram of visitors waiting in line for an attraction, according to an aspect of the present disclosure. As shown in FIG. 7, a number of visitors 201 are waiting in line to ride on an attraction 210a. Sensors 390a positioned adjacent a waiting area for an attraction uses one of the aforementioned communication techniques for determining the number of visitors in line for the attraction 210a. In the present example shown, two sensors 390a, 390a to sense a presence of visitors 201 over a linear distance. The monitor 391a positioned in an adjacent area of the attraction 310 monitors a condition of the attraction 210. For example, the monitor 391 may detect whether the attraction is operation or down for maintenance. The monitor 391 may detect the operation information of the attraction 210 directly or by operator input into the monitor 391. The controller 392a facilitates transmission of the information in the sensor 390a and the monitor 391a to the attraction server 380.

In one embodiment, the monitors 391a-d include RFID tags with which maintenance history is recorded on the RFID tags and transmitted for storage in the attraction maintenance database 382.

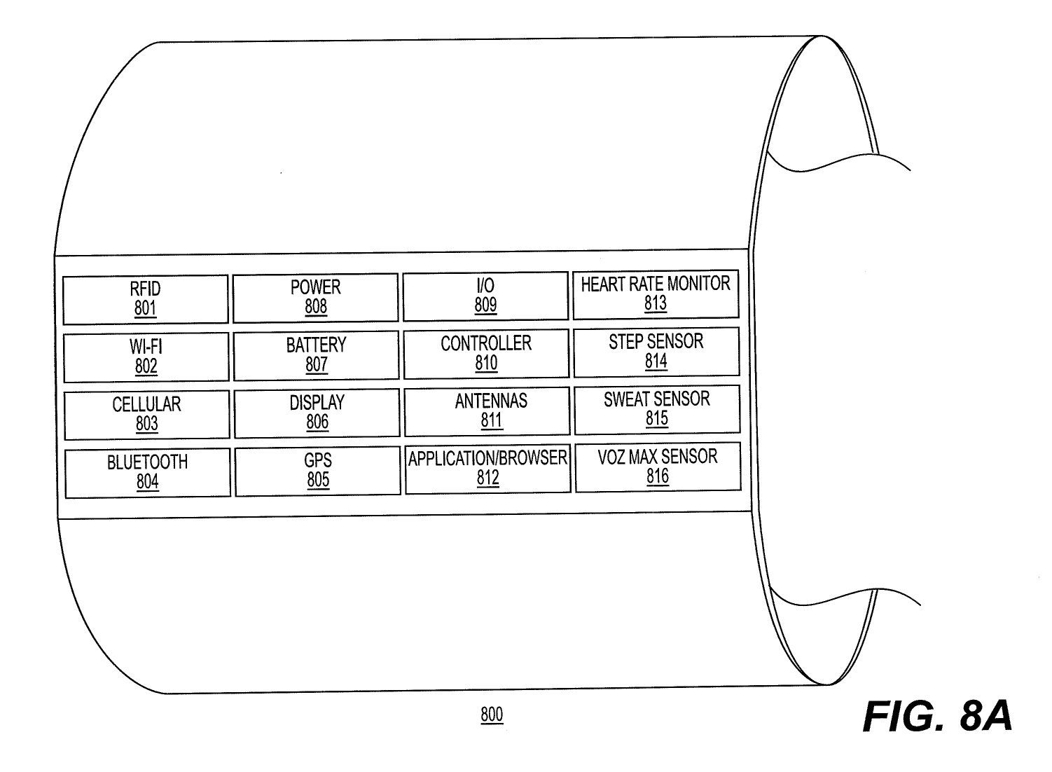

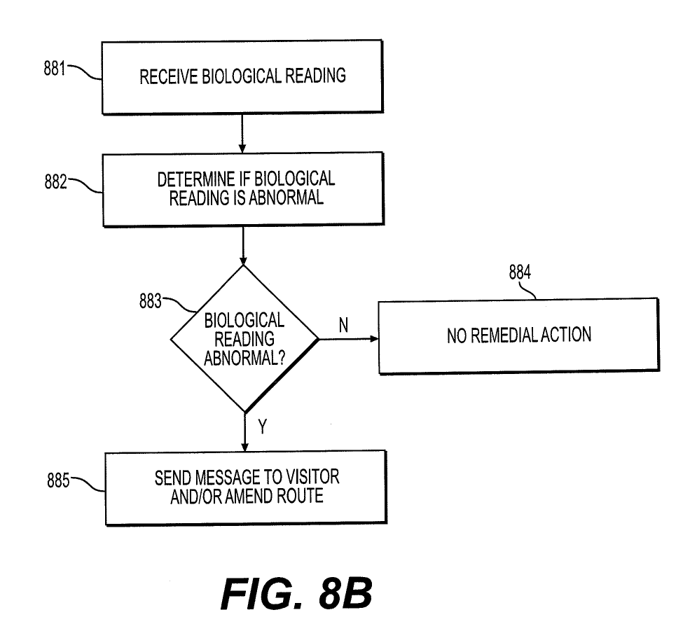

FIG. 8A shows exemplary circuit components of a wearable monitor band, according to an embodiment of the present disclosure. According to the embodiment of FIG. 8, the wearable monitor band 800 is used in place of the smartphone discussed above. Thus, the wearable monitor band 800 may also serve as the electronic ticket of the visitor 201.

The wearable monitor band 800 may include an RFID module 801, a Wi-Fi module 802, a cellular module 803, a Bluetooth™ module 804, a GPS module 805, a display 806, a battery 807, power control 808, I/O interface 809, a controller 810, one or more antennas to support RFID, Wi-Fi, cellular, and/or Bluetooth™ communications 811, a browser 812, a heart rate monitor 813, a step sensor 814, a sweat sensor 815, and a VO₂ sensor 816.

The band 800 may be implemented using any appropriate hardware and software configured for wired and/or wireless communications over wireless networks. The browser application may be used, for example, to provide an interface to allow the visitor 201 to browse information over the Internet.

The visitor 201 may wear the band 800 that may include a radio frequency identification (“RFID”) tag 801. The RFID tag 801 may be affixed or provided with the wrist band 800 or to any other wearable or carried technology. The RFID tag 801 is configured to communicate and interact with tag sensors or beacons provided in strategic locations about the venue 200. For example, the tag sensors in the venue are located at various strategic locations, including at rides, along routes, at restaurants, etc. Thus, the band 800 having RFID tag 801 sends and receives RF signals through an antenna in or on the band 800 that enables it to be detected by various short-range and long-range tag sensors or points within the venue 200.

When the RFID tag 801 is moved within the predetermined distance of one of the tag sensors, data from the RFID tag 801 is transmitted to the tag sensor. The data transmitted to the tag sensor includes information that allows the visitor 201 to be identified by identifying indicia such as an identification number. The information may also allow the visitor 201 to be identified by name or other demographic information. The RFID tag 801 may also include information that allows the visitor to be identified according to specific attractions and number of attractions visited during the visitor's present visit to the venue 200, and may include historical information as to the attractions that the visitor 201 has ever visited in the venue 200, etc.

Via RFID proximity tagging, location information of the visitor 201 may be obtained. The obtained location of the visitor 201 may be transmitted to the visitor position database 355.

The band 800 may also be provided with the Wi-Fi module 802 and/or a cellular module 803 and/or the Bluetooth™ module 804 to transmit information over a network. The Bluetooth module 804 may be configured to implement low energy Bluetooth (BLE) communication. For example, band 800 may detect various low energy Bluetooth signals from Bluetooth beacons installed at specific locations in the venue 200. Thus, the location and movements of the visitor 201 in the venue 200 may be detected by the various Bluetooth beacons.

The wearable band 800 may include a GPS receiver to receive location information of the visitor 201. For example, the GPS receiver may receive a GPS signal and thus provide the location of the visitor 201, which may be transmitted to the visitor position database 355.

The application 807 on the band 800 may allow the user to receive the survey questions from the web registration server 361. The survey may be displayed on the display 806 so that the user can respond to the survey questions with one or more of the I/O interfaces 808.

The wearable band may also include at least one processor, such as a microprocessor controller, having at least one memory or storage. The wearable band may also include an I/O interface having a GUI. The tracker may also include circuitry by which a battery supplies power to the wearable band. The microprocessor is configured to process the obtained location information, which identifies the location of the visitor wearing the wearable band.

The GPS receiver circuitry may be used to receive and obtain the location of the wearable band. While the wearable band includes a GPS receiver, location information may also be obtained via alternative technologies, such as RFID proximity tagging, Bluetooth beacon technology, Wi-Fi triangulation, wide area network (or cellular) location assisted technology, or any combination of these technologies.

As noted, the visitors 201a-n may be detected by BLE beacons, GPS, NFC, or RFID, for example. For example, the system may detect when the visitor 201 joins a line and when the visitor 201 leaves a line. The beacons may also be located at various strategically placed locations about the venue 200 to detect visitors wearing the band 800.

The battery 807 is configured to supply power to the band 800 and is controlled by the power manager 808. The controller 810 controls the various modules and functionalities of the band 800.

In one embodiment, the band 800 may be a wearable bracelet, wristband, necklace, anklet, or other wearable or carryable item. Locations for the beacons include adjacent attractions 210a-n, in or around food courts, and stands, etc.

The heart rate monitor 813 may be, for example, an optical heart rate monitor. For example, the optical heart rate monitor may be configured to use light to measure a pulse of the visitor 201. That is, a light is transmitted into the blood vessels in a wrist of the visitor, such that a detection of changes in blood volume that occur with every heart beat is detected, thus detecting how much light in the blood vessels is reflected back, with less reflected light corresponding to a higher blood volume. In another embodiment, the heart rate monitor 813 may detect electrical activity, generated as the heart beats, through the skin of the visitor 201.

The step sensor 814 may be a multi-axis accelerometer that turns movement such as acceleration into digital data. An algorithm determines whether a motion's magnitude qualifies as a step by determining whether a predetermined threshold has been met. The step sensor is configured to record the number of steps taken by the visitor 201, which the visitor position/activity server 356 receives for storage into the visitor position/activity database 355, which is later received by the route/activity calculation module 371

The sweat sensor 815 may be configured to detect hydration, lactic acid, and calories burned from sweat of the visitor. The VO₂ sensor may be configured to estimate the visitor's aerobic fitness level via linear or nonlinear dependency between a heart rate of the visitor 201 and speed of the visitor 201.

FIG. 8B is an exemplary flow diagram illustrating logic for receiving a biological parameter from the wearable band of the visitor.

At step 881, a biological parameter is received via the wearable band 800 of the visitor. For example, sweat collected from the sweat sensor 815 can detect and provide information about the visitor's hydration level, fluid loss, electrolytes, metabolites. For example, an embedded electrochemical sensor or sensors in the sweat sensor can detect biomarkers in sweat such as glucose, cortisol, sodium, potassium, lactate, pH, etc.

At step 882, logic in the visitor position/activity server 356 analyzes the biological fluid received to obtain a physiological parameter (e.g., a numerical value corresponding to a level of one of the biomarkers, electrolytes, metabolites, etc.) and determines whether an abnormal reading exists. At step 883, if an abnormal reading is determined to exist, a message or a modified route is sent to the visitor at step 885. Thus, if the visitor is on the verge of dehydration, the route/activity calculation module 371 can adjust the route of the visitor, or transmit a message to the visitor. For example, the message to the visitor may encourage the visitor to take a rest, take a transportation option such as a shuttle, or to seek medical help in the venue 200. However, if an abnormal reading is determined not to exist, no action is taken at step 884.

In this regard, the visitor position/activity database 355 stores a table consisting of the normal ranges of biological parameters for, for example, hydration level, fluid loss, electrolytes, metabolites, glucose, cortisol, sodium, potassium, lactate, pH, etc. Different ranges may be stored for men, women, children, by age group, by persons with special medical conditions, etc. Thus, a determination of what constitutes abnormal may be made based on a demographic profile of the visitor.

As another example, rather than sweat, the biological parameter upon which a determination is made at step 883 is a heart rate of the visitor 201 obtained by the heart rate monitor 813.

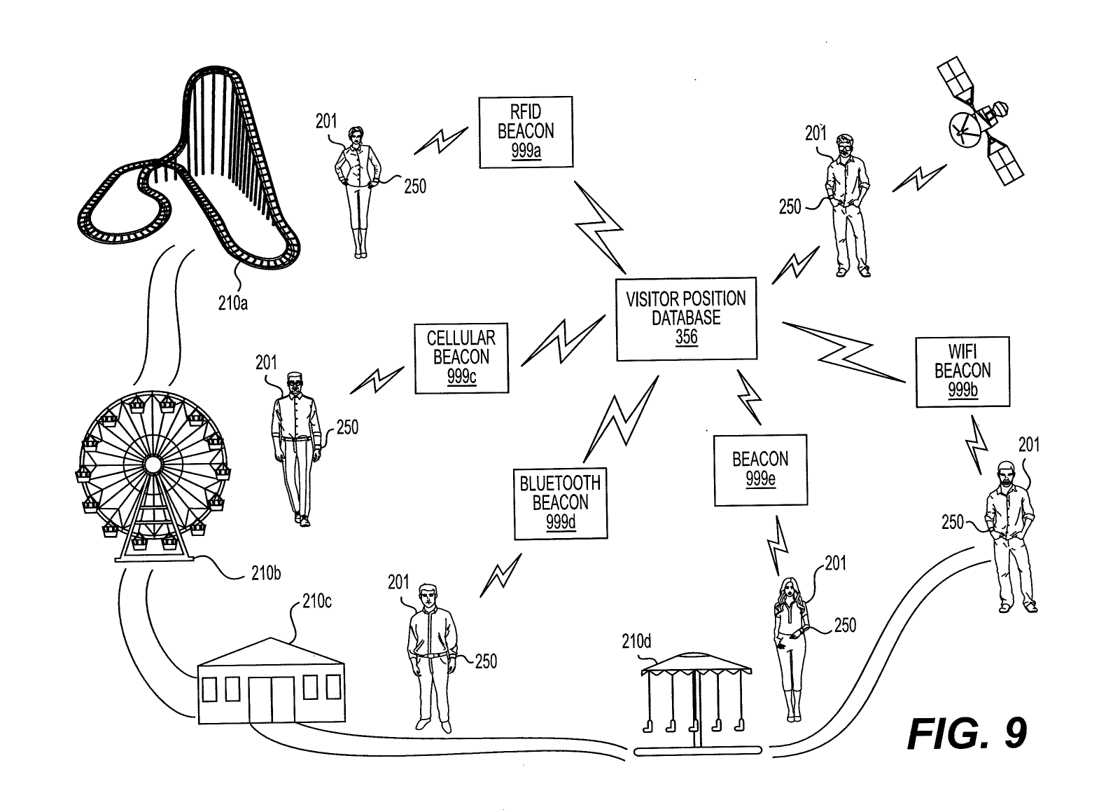

FIG. 9 shows an exemplary diagram of beacons in the venue, according to an aspect of the present disclosure.

Beacons 999a-e may be located in a plurality of sensing locations throughout the venue 200 and are configured to output signals to convey information related to the physical locations of the beacons 999a-e in the venue 200. The beacons 999a-e are configured to exchange signals with the band 800 to identify the position of the visitor 201 as the visitor traverses the venue 200.

As shown, the beacons 999a-e include an RFID beacon 999a, a Wi-Fi beacon 999b, a cellular beacon 999c, a Bluetooth beacon 999d. Signaling transmitted from the mobile devices 250a-c to the beacons 999a-e is sent to the visitor position/activity server 356 for storage in the visitor/activity position database 355. For example, the location of each beacon 999a-e is known, so that when information from the mobile devices 250a-c is exchanged with the beacons 999a-e, including identification information associated with the particular mobile device 250 and particular visitor 201, the location of the visitor 201 can be established. GPS location information of the visitor 201 may be detected by a beacon 999e and sent to the visitor position database 356 via one of the aforementioned wireless communication methods or alternatively, the GPS location information may be sent directly from the mobile device 250 of the visitor 201 to the visitor position database 356.

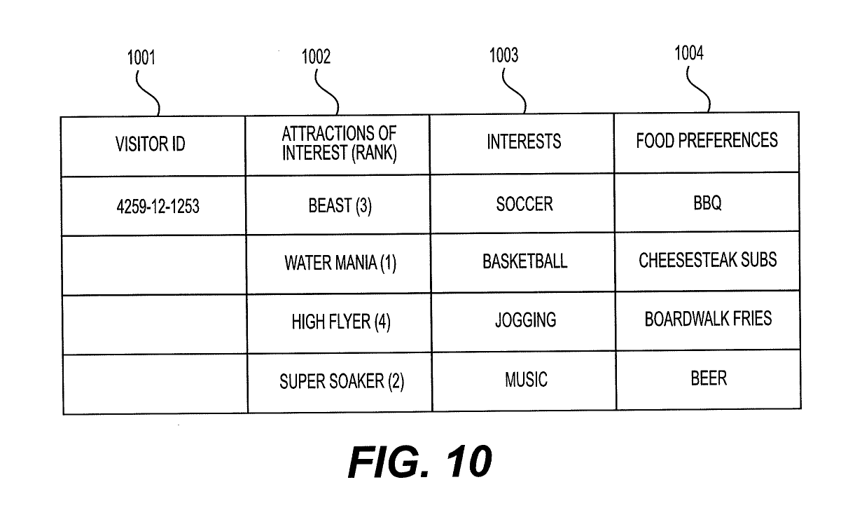

FIG. 10 shows an exemplary visitor record, according to an aspect of the present disclosure. That is the first column 1001 is an identification number of the mobile device 250 and/or the visitor 201. The second column 1002, taken from the survey completed by the visitor 201, is a listing of attractions ranked by the visitor 201 that the visitor wishes to attend during the visit to the venue 200, e.g., Beast, Water Mania, High Flyer, Super Soaker. As indicated in FIG. 10, the visitor has ranked their attractions from most desired to least desired as Water Mania (1); Super Soaker (2); Beast (3); and High Flyer (4), potentially indicating a preference for water attractions.

The third column 1003 is a list of interests of the visitor 201 as indicated by the visitor 201 on the survey, e.g., soccer, basketball, jogging, music. The fourth column 1004 is a list of the food preferences of the visitor as indicated by the visitor 201 on the survey, e.g., BBQ, Cheesesteak Subs, Boardwalk Fries, Beer.

FIG. 11 shows an exemplary visitor target activity level record for electronic routing and messaging in a venue based on activity level, according to an aspect of the present disclosure.

During the initial aforementioned survey, the visitor 201 is presented with an interface on the mobile device 250 where the visitor 201 can indicate a desired activity level, or the visitor 201 can select from specific activity levels.

For example, in column 1101, the visitor 201 can select via the mobile device 250 to walk or traverse a certain range of distances, or specify a specific distance, e.g., 0.1 k-3 k; 3 k-5 k; 5 k-7.5 k; 7.5 k-10 k; 10 k-15 k; or over 15 k. Of course, any suitable ranges or specific distances may be used. Additionally, the visitor 201 can specify a particular distance that they would like to traverse during the visit. As a result of the distance range or specific distance entered, the route/activity calculation module 371 will tailor and recommend the visitor route(s) so that the visitor 201 will be on target to meet that objective.

Similarly, in column 1102, the visitor 201 can select via the interface on the mobile device 250 to target to expend a certain amount of calories during while traversing the venue 200, e.g., 0-500 calories; 500-1000 calories; 1000-1500 calories; 1500-2000 calories; 2000-2500 calories; or over 2500 calories. Of course any suitable caloric ranges or specific caloric amounts may be used. Additionally, the visitor can specify a particular caloric expenditure that they would like to meet during the visit. As a result of the caloric range or specific caloric value entered, the route/activity calculation module 371 will tailor and recommend the visitor route(s) so that the visitor 201 will be on target to meet that objective.

Similarly, in column 1103, the visitor 201 can select via the interface on the mobile device 250 desired conditions that the visitor 201 would prefer to experience during the visit to the venue 200, e.g., outside attractions, inside attractions, wet conditions, dry conditions, cool/cold conditions, warm/hot conditions, humid conditions, etc. Additionally, the visitor can specify particular desired conditions that they would like to encounter during the visit.

As a result, the system advantageously enables venue operators to route priority visitors away from attractions that the visitors have previously indicated that they are interested in going to, when the estimate wait time is determined to be too long, which would result in lower satisfaction levels. Instead, the visitors would be routed to alternate attractions that still match the visitors' interests, but that such alternate attractions have shorter current wait times. Thus, the overall visitor satisfaction level is much more likely to be high, leading to positive reviews and repeat visits.

Thus, the system advantageously enables venue operators to route priority visitors away from attractions that the visitors have previously indicated that they are interested in going to, when the estimate wait time is determined to be too long, which would result in lower satisfaction levels. Instead, the visitors would be routed to alternate attractions that still match the visitors' interests, but that such alternate attractions have shorter current wait times. Thus, the overall visitor satisfaction level is much more likely to be high, leading to positive reviews and repeat visits.

The system enables a collection of data from environmental, ride traffic, visitor position, and historic weather database information to facilitate venue day planning, which routes visitors through the venue based on desired activity level. Visitors at the venue enter information related to their desired attractions and desired activity level upon arrival to the venue. Using the visitor entered information, the system produces recommended routes and plans for experiencing the venue. Furthermore, activity level is also related to meal planning for the guests and menu selections are aligned with activity level. The visitor wearable band is used as a caloric fit-band that adds real time sensor data to see how well the planned activity is aligning with real time data. Thus, the routes in the venue may change based upon the increase or decrease of activity level.

Accordingly, visitor tracking devices, environmental sensors and weather forecasting data along with visitor input about the attractions the visitor want to see on their visit and how much or little exercise they wish to get in order to customize their route through the venue. Route distances are optimized for activity level desired. If the desired activity level is below the most efficient route, transportation options (such as trams, buses, scooters, etc.) are incorporated. If the environmental data or weather forecast data, indicate the temperature/humidity exceeds certain thresholds, indoor and shady portions of the route are maximized.

Although electronic routing and messaging in a venue based on activity level has been described with reference to several exemplary embodiments, it is understood that the words that have been used are words of description and illustration, rather than words of limitation. Changes may be made within the purview of the appended claims, as presently stated and as amended, without departing from the scope and spirit of electronic routing and messaging in a venue based on activity level in its aspects. Although electronic routing and messaging in a venue based on activity level has been described with reference to particular means, materials and embodiments, electronic routing and messaging in a venue based on activity level is not intended to be limited to the particulars disclosed; rather electronic routing and messaging in a venue based on activity level extends to all functionally equivalent structures, methods, and uses such as are within the scope of the appended claims.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present specification describes components and functions that may be implemented in particular embodiments with reference to particular standards and protocols, the disclosure is not limited to such standards and protocols. For example, standards such as (Wi-Fi, Bluetooth, RFID, Cellular, GPS, NFC) represent examples of the state of the art. Such standards are periodically superseded by more efficient equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of the disclosure described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

According to an aspect of the present disclosure, a method is provided for messaging and routing a visitor through a venue. The method includes acquiring, using a processor of a computer, data relating to desired attractions of a visitor and a desired activity level of the visitor. The method further includes recommending, using the processor, at least one of a route, venue activity, transportation mode, and food menu selection based on the desired attractions of the visitor and the desired activity level of the visitor. In addition, the method includes tracking a current location of the visitor via a wearable device of the visitor. Further, the method includes acquiring, using the processor, a current activity level of the visitor via the wearable device of the visitor. A comparison is performed using the processor, of the current activity level of the visitor to the desired activity level of the visitor. The method includes updating, using the processor, at least one of the recommendation of the route, venue activity, transportation mode, and food menu selection based on the current location of the visitor and a comparison of the current activity level of the visitor with the desired activity level of the visitor.

According to another aspect of the present disclosure, acquiring a current activity level of the visitor includes receiving heart rate information of the visitor, and receiving a number of steps taken by the visitor.

According to yet another aspect of the present disclosure, the method may include receiving at least one physiological parameter derived from a biological fluid of the visitor, in which the biological fluid of the visitor comprises sweat of the visitor, and in which the biological fluid is detected by an electrochemical sensor in the wearable device of the visitor.

According to a further aspect of the present disclosure, the method may include modifying the route of the visitor in response to receiving the at least one physiological parameter derived from the biological fluid of the visitor and determining that the physiological parameter is abnormal for a demographic profile of the visitor, and sending a modified route to the visitor.

According to another aspect of the present disclosure, the method may include sending a message to the visitor in response to receiving the at least one physiological parameter from the biological fluid of the visitor, and determining that the physiological parameter is abnormal for a demographic profile of the visitor.

According to yet another aspect of the present disclosure, the desired activity level of the visitor includes a desired caloric expenditure of the visitor while at the venue, and a desired distance that the visitor would like to traverse while at the venue.

According to still another aspect of the present disclosure, the method may include acquiring, using the processor, environmental data. The environmental data is acquired via at least one weather sensor in the venue. The at least one weather sensor may include a thermometer, a hygrometer, and/or a light level sensor.

According to another aspect of the present disclosure, the current location of the visitor is detected via signals sent from the wearable device of the visitor to at least one sensor in the venue, and the sensor transmits location information to a centralized server.

According to yet another aspect of the present disclosure, the at least one sensor comprises an RFID sensor and/or a Wi-Fi sensor.

According to a further aspect of the present disclosure, the current location of the visitor is detected via GPS signals sent from the wearable device of the visitor.

According to still a further aspect of the present disclosure, the current activity level of the visitor is detected by a VO2 sensor on the wearable device.

According to an aspect of the present disclosure, the method may include transmitting a food selection recommendation to the visitor based upon a difference between a desired caloric expenditure and an estimated caloric expenditure.

According to an aspect of the present disclosure, the method may include setting an itinerary including a plurality of attractions based on the desired attractions of the visitor and the desired activity level of the visitor, and updating, using the processor, the itinerary based on the current location of the visitor and the comparing of the current activity level of the visitor with the desired activity level of the visitor.

According to another aspect of the present disclosure, a tangible non-transitory computer readable storage medium is provided that stores a computer program. The computer program, when executed by a processor, causes a computer apparatus to perform a process. The process includes acquiring data relating to desired attractions of a visitor and a desired activity level of the visitor. Environmental data and weather forecast data is acquired. A recommendation of at least one of a route, venue activity, transportation mode, and food menu selection is made based on the desired attractions of the visitor, the desired activity level of the visitor, the environmental data and the weather forecast data. A current location of the visitor is tracked via a wearable device of the visitor. A current activity level of the visitor is acquired via the wearable device of the visitor. A comparison of the current activity level of the visitor and the desired activity level of the visitor is made. The recommendation of the route, venue activity, transportation mode, and food menu selection is updated based on the current location of the visitor and a comparison of the current activity level of the visitor with the desired activity level of the visitor.

According to another aspect of the present disclosure, a computer apparatus is provided including a memory that stores instructions, and a processor that executes the instructions. When executed by the processor, the instructions cause the processor to perform operations. The operations include includes acquiring data relating to desired attractions of a visitor and a desired activity level of the visitor. Environmental data and weather forecast data is acquired. A recommendation of at least one of a route, venue activity, transportation mode, and food menu selection is made based on the desired attractions of the visitor, the desired activity level of the visitor, the environmental data and the weather forecast data. A current location of the visitor is tracked via a wearable device of the visitor. A current activity level of the visitor is acquired via the wearable device of the visitor. A comparison of the current activity level of the visitor and the desired activity level of the visitor is made. The recommendation of the route, venue activity, transportation mode, and food menu selection is updated based on the current location of the visitor and a comparison of the current activity level of the visitor with the desired activity level of the visitor.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The preceding description of the disclosed embodiments is provided to enable any person skilled in the art to make or use the present disclosure. As such, the above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for messaging and routing a visitor through a venue, comprising:
acquiring, using a processor of a computer, data relating to desired attractions of a visitor and a desired activity level of the visitor;
recommending, using the processor, at least one of a route, venue activity, transportation mode, and food menu selection based on the desired attractions of the visitor and the desired activity level of the visitor,
tracking a current location of the visitor via a wearable device of the visitor;
acquiring, using the processor, a current activity level of the visitor via the wearable device of the visitor;
comparing, using the processor, the current activity level of the visitor to the desired activity level of the visitor;
updating, using the processor, at least one of the recommendation of the route, venue activity, transportation mode, and food menu selection based on the current location of the visitor and a comparison of the current activity level of the visitor with the desired activity level of the visitor.

2. The method of claim 1, wherein acquiring a current activity level of the visitor comprises:
receiving heart rate information of the visitor; and
receiving a number of steps taken by the visitor.

3. The method of claim 2, further comprising:
receiving at least one physiological parameter derived from a biological fluid of the visitor,
wherein the biological fluid of the visitor comprises sweat of the visitor,
and wherein the biological fluid is detected by an electrochemical sensor in the wearable device of the visitor.

4. The method of claim 3, further comprising:
modifying the route of the visitor in response to receiving the at least one physiological parameter derived from the biological fluid of the visitor and determining that the physiological parameter is abnormal for a demographic profile of the visitor; and
sending a modified route to the visitor.

5. The method of claim 3, further comprising:
sending a message to the visitor in response to receiving the at least one physiological parameter from the biological fluid of the visitor; and
determining that the physiological parameter is abnormal for a demographic profile of the visitor.

6. The method of claim 1, wherein the desired activity level of the visitor comprises:
a desired caloric expenditure of the visitor while at the venue; and
a desired distance that the visitor would like to traverse while at the venue.

7. The method of claim 1, further comprising:
acquiring, using the processor, environmental data, wherein the environmental data is acquired via at least one weather sensor in the venue.

8. The method of claim 7, wherein the at least one weather sensor comprises a thermometer.

9. The method of claim 7, wherein the at least one weather sensor comprises a hygrometer.

10. The method of claim 7, wherein the at least one weather sensor comprises a light level sensor.

11. The method of claim 1, wherein the current location of the visitor is detected via signals sent from the wearable device of the visitor to at least one sensor in the venue,
and wherein the sensor transmits location information to a centralized server.

12. The method of claim 11, wherein the at least one sensor comprises an RFID sensor.

13. The method of claim 11, wherein the at least one sensor comprises a Wi-Fi sensor.

14. The method of claim 11, wherein the at least one sensor comprises an RFID sensor and a Wi-Fi sensor.

15. The method of claim 1, wherein the current location of the visitor is detected via GPS signals sent from the wearable device of the visitor.

16. The method of claim 1, wherein the current activity level of the visitor is detected by a VO₂ sensor on the wearable device.

17. The method of claim 1, further comprising transmitting a food selection recommendation to the visitor based upon a difference between a desired caloric expenditure and an estimated caloric expenditure.

18. The method of claim 1, further comprising:
setting an itinerary including a plurality of attractions based on the desired attractions of the visitor and the desired activity level of the visitor; and
updating, using the processor, the itinerary based on the current location of the visitor and the comparing of the current activity level of the visitor with the desired activity level of the visitor.

19. A tangible non-transitory computer readable storage medium that stores a computer program, the computer program, when executed by a processor, causing a computer apparatus to perform a process comprising:
acquiring data relating to desired attractions of a visitor and a desired activity level of the visitor;
acquiring environmental data and weather forecast data;
recommending at least one of a route, venue activity, transportation mode, and food menu selection based on the desired attractions of the visitor, the desired activity level of the visitor, the environmental data and the weather forecast data,
tracking a current location of the visitor via a wearable device of the visitor;
acquiring a current activity level of the visitor via the wearable device of the visitor;
comparing the current activity level of the visitor to the desired activity level of the visitor;
updating the recommendation of the route, venue activity, transportation mode, and food menu selection based on the current location of the visitor and a comparison of the current activity level of the visitor with the desired activity level of the visitor.

20. A computer apparatus, comprising:
a memory that stores instructions, and
a processor that executes the instructions,
wherein, when executed by the processor, the instructions cause the processor to perform operations comprising:
acquiring data relating to desired attractions of a visitor and a desired activity level of the visitor;
acquiring environmental data and weather forecast data;
recommending at least one of a route, venue activity, transportation mode, and food menu selections based on the desired attractions of the visitor, the desired activity level of the visitor, the environmental data and the weather forecast data,
tracking a current location of the visitor via a wearable device of the visitor;
acquiring a current activity level of the visitor via the wearable device of the visitor;
comparing the current activity level of the visitor to the desired activity level of the visitor;
updating the recommendation of the route, venue activity, transportation mode, and food menu selection based on the current location of the visitor and a comparison of the current activity level of the visitor with the desired activity level of the visitor.
